(19) United States
(12) Patent Application Publication
(10) Pub. No.: US 2006/0023876 A1
(43) Pub. Date: Feb. 2, 2006

(54) Method to secure a broadcasted event

(76) Inventors: Rached Ksontini, Lausanne (CH); Henri Kudelski, Grandvaux (CH)

Correspondence Address: HARNESS, DICKEY & PIERCE, P.L.C., P.O. BOX 8910, RESTON, VA, 20195, US

(21) Appl. No.: 11/074,688

(22) Filed: Mar. 9, 2005

(30) Foreign Application Priority Data
Mar. 10, 2004 (EP) 04100969.7
Jun. 11, 2004 (EP) 04102667.5

(51) Int. Cl. H04L 9/28

(52) U.S. Cl. 380/28

(57) ABSTRACT

The aim of this invention is to propose a solution to prevent the modification of access conditions to an encrypted multimedia content. This aim is achieved by a method to secure an event with control words (CW), the use of this event by user units being subjected to access conditions (AC), said method comprising the following steps: generation of a pseudo-random number (RNG), formation of a control block (CB) by the association of the pseudo-random number (RNG) and the access conditions (AC), calculation of the control word (CW) by the application of a unidirectional function (F) on the control block (CB), use of the control word (CW) to encrypt the event, transmission of the control block (CB) to the user units.

### BACKGROUND OF THE INVENTION

1. Field of the Invention

The present invention refers to the domain of Pay-TV, in particular audio/video data encryption known as Common Scrambling.

These systems are used in particular in the domain of digital pay television. In this case, the digital data stream transmitted towards the television set is enciphered in order to enable its usage control and to define conditions for this usage. This enciphering is carried out thanks to control words that are changed at regular intervals (typically between 5 and 30 seconds, although notably longer intervals can be used) in order to dissuade any attack aiming to find such a control word.

In order for the receiver to be able to decipher the stream enciphered with these control words, the latter are sent independently of the stream in control messages (ECM) enciphered by a key pertaining to the transmission system (transmission key) between a management center and a security module of the user unit. In fact, the security operations are carried out in a security module (SC) that is generally made in the form of a smart card, reputed to be tampering proof. The transmission key serving to encrypt the control messages is common to all the security modules and is changed regularly. It can be of the symmetrical or asymmetrical type according to implementation.

This security module can be either of the removable type or can be directly integrated into the receiver (BGA circuit for example).

During the deciphering of a control message (ECM), it is verified, in the security module (SC), that the right to access the concerned stream is present. This right can be managed by authorization messages (EMM) that load such a right into the security module. Other possibilities are also imaginable such as the sending of deciphering keys.

In the following, the term “event” refers to a video or audio content (for example MP3) or data (game program for example) that is enciphered according to the known method of control words, each event can be enciphered by one or more control words, each having a determined validity duration.

The security module is reputedly tampering proof. Nevertheless, with very important means it is possible to extract the secrets contained in this type of module (transmission key, for example).

This ability allows a malicious third party to access the content of the control messages and to modify them, for example, by changing the conditions linked to the deciphering of the control words CW. Once this operation has been carried out a new message is generated, also thanks to the transmission key and this message is transmitted to all the illicit beneficiaries, clients of the third party.

One can imagine that in this way the malicious third party modifies the access conditions of all the broadcasted events to give them the status of “free”. All the users of these messages, having a minimal subscription, can take advantage of all the offers of the supplier without having to pay the corresponding price. For this purpose the malicious user disposes of a conventional decoder with a security module which always up-to-date at the cryptographic level. In spite of this, the service supplier will see a part of his revenue despoiled by the practice of the malicious third parties, without means to remedy the situation.

A first method to prevent this phenomenon requires a feedback channel. The knowledge of the events effectively consumed allows the updating of a difference in the rights allocated to a user and the events consumed with this right.

In the absence of a feedback channel, the service supplier cannot prevent this type of abusive use.

2. Description of the Prior Art

In the book “Handbook of applied cryptography” by Mezenes et al, (ISBN 0-8493-8523-7) page 498, the use of a random number r_{A} is described that is used as a key after a unidirectional function has been applied on this number. In the context of Pay-TV, this method does not offer any solution to the problem of the modification of the access conditions. In fact, these conditions are not concern by this mechanism and if as a hypothesis the security module was violated, the control word transmitted in the form as disclosed in this document can be recovered and broadcasted again to malicious third parties.

The document U.S. Pat. No. 6,157,719 clearly illustrates the prior art, namely the use of a random generator to generate the enciphering keys of the content and the sending of this key in an enciphered message (FIG. 2A). The access conditions to the content are included in the ECM message and a hash function is used to authenticate the message (column 6, line 45). The control word CW is always encrypted (column 6, line 51) before sending.

### SUMMARY OF THE INVENTION

The aim of this invention is to propose a solution to prevent the abusive use of the secrets revealed by the internal analysis of the security module.

This aim is reached by a method to secure an event with control words, the use of this event by user units being subject to access conditions, said method comprising the following steps:
generation of a pseudo-random number,
formation of a control block by the association of the pseudo-random number and the access conditions,
calculation of the control word by the application of a unidirectional function on the control block,
use of the control word to encrypt the event,
transmission of the control block to user units.

Therefore, the solution of the invention consists in allowing the intervention of the access conditions in the control word (or key) of data encryption.

The unidirectional function is known in itself and, for example, is of the Hash type.

This operation guarantees that a third party, knowing the control word, cannot reproduce a data block with other access conditions.

If the access conditions are modified, the licit security module of a user unit will calculate the control word using different access conditions and the resulting control word will not be correct. Therefore, the event cannot be decrypted.

### BRIEF DESCRIPTION OF THE DRAWINGS

The invention will be better understood thanks the following detailed description that refers to the enclosed drawings that are given as a non-limitative example, namely:

FIG. 1 shows the generation of a control word,

FIG. 2 shows the processing of a message comprising two control words.

### DETAILED DESCRIPTION

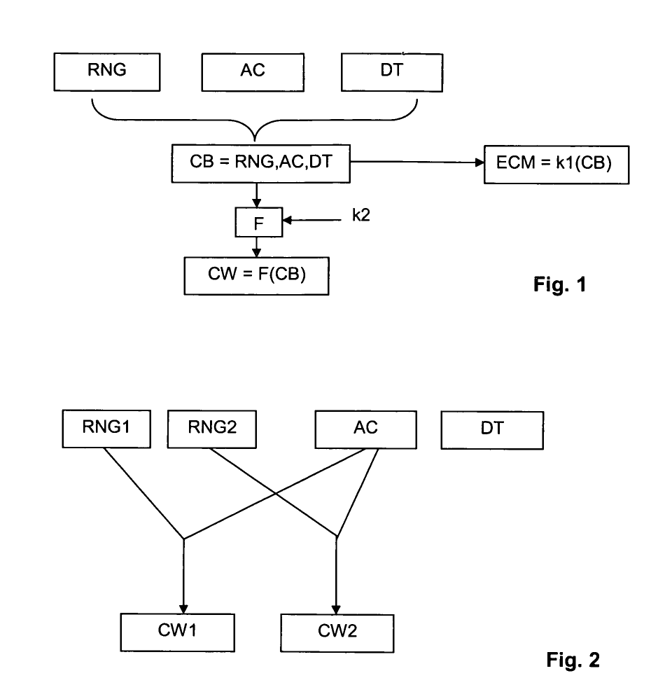

In FIG. 1, a first variable element is generated in pseudo-randomly way, the variable RNG. This is a variable that can be generated randomly, or obtained through a secret table or in any other way that cannot be predicted in advance. The second element is constituted by access conditions AC to the event. These conditions define the necessary rights that the user must have in order for the security module of said user to return the control word to the decoder. It relates to the description of a subscription, to a right linked to said event or to an amount to be debited to the credit contained in the security module.

According to the invention, the two parameters variable and access conditions are both elements necessary to form the control word. Optionally, provision is made to add the date DT of broadcasting, this date being able to play an important role when the validity of a subscription has to be verified. In fact, if a subscription has not been renewed, the manipulation of this date can induce the security module in error in the way that the event can be visualized because the date of said event is included in a validity period of the subscription.

According to our example, the control block CB includes the three elements, namely the variable RNG, the access conditions AC and the date DT.

This block is then converted by a unidirectional function F such as a Hash function.

The result is unique for the whole control block and the modification of a bit of the block causes the complete modification of the output of the function. It is considered that it is not possible to determine the control block on the basis of the result of this function.

The output of this function constitutes the control word CW and is used to encrypt all or part of the event.

The control block is transmitted towards the decoder in an ECM message. According to a first variant, this message is encrypted with a transmission key k1.

During the reception by the decoder and subsequently by the security module, the message is decrypted with the corresponding key k1 and the same unidirectional function F is applied to the control block CB to obtain the control word.

It is noted thus that the modification of any part of the control block, the access conditions for example, results in the obtainment of an incorrect control word.

According to a second variant, the unidirectional function F is configured with a key k2. Such functions are known and use the key as an initialization vector.

This supplementary security allows considering the transmission of the control block CB in clear, namely without encryption with the key k1.

FIG. 2 illustrates an example of a message comprising two control blocks for the preparation of two control words. It should be noted that the decoder must dispose of the current control word and the subsequent control word in order to ensure a transition without interruptions between the part of the event encrypted with the first control word and the part of the event encrypted with the second control word.

For this reason, the message contains two variables RNG1 and RNG2. Due to the fact that it is considered that the access conditions are identical for these two control words, they are thus calculated on the basis of the variable and the access conditions such as disclosed in FIG. 2.

1. Method to secure an event with control words, the use of this event by user units being subjected to access conditions, said method comprising the following steps:
generation of a pseudo-random number,
formation of a control block by the association of the pseudo-random number and the access conditions,
calculation of the control word by the application of a unidirectional function on the control block,
use of the control word to encrypt the event,
transmission of the control block to the user units.

2. Method according to claim 1, wherein the unidirectional function is initialized by an encryption key.

3. Method according to claim 1, wherein the current date is added at the control block and participates in the formation of the control word.

4. Method according to claim 2, wherein the control message includes the data block in clear.

5. Method according to claim 1, wherein the control message includes the data block in the form encrypted with a transmission key.

6. Method according to claim 1, wherein the control message includes two variables, which in combination with the access conditions and the unidirectional function, allow the generation of two control-words respectively.
